(19) United States
(12) Patent Application Publication
(10) Pub. No.: US 2020/0195051 A1
(43) Pub. Date: Jun. 18, 2020

(54) Phone-Supported Metal Detector

(71) Applicant: Integrated Device Technology, Inc., San Jose, CA (US)

(72) Inventor: Nicholaus SMITH, La Mesa, CA (US)

(21) Appl. No.: 16/379,681

(22) Filed: Apr. 9, 2019

Related U.S. Application Data
(60) Provisional application No. 62/781,572, filed on Dec. 18, 2018.

(51) Int. Cl. H02J 50/12; H02J 50/60; G01V 3/10

(52) U.S. Cl. CPC H02J 50/12; H02J 7/025; G01V 3/10; H02J 50/60

(57) ABSTRACT

According to some embodiments, a phone having a metal detector function is presented. In some embodiments, the phone includes a transmit coil and a microcontroller coupled to drive the transmit coil, the microcontroller monitoring a current or a voltage on the transmit coil and indicating the presence of a metal object.

### CROSS-REFERENCE

This application claims the benefit, under 35 U.S.C. § 119(e), of co-pending and commonly-owned U.S. provisional application No. 62/781,572, filed on Dec. 18, 2018, which is hereby expressly incorporated herein by reference in its entirety.

### TECHNICAL FIELD

Embodiments of the present invention are related to operations of wireless power transmitters in a phone as part of a metal detector.

### DISCUSSION OF RELATED ART

Increasingly, smart phones include wireless power transfer systems, including wireless power transmitters for sharing wireless power with other devices. Such smart phones usually include a transceiver coupled to an inductive coil. The inductive coil can be configured as a transmitter coil to transmit wireless power to another device, or be configured as a receiver coil to receive wireless power from another source. Existing devices usually dedicate the inductive coils for wireless power transfer. As the inductive coil can be costly and takes up space on the circuit board of a device, limiting the use of the inductive coil to wireless power transfer leads to a waste of hardware resource.

Therefore, there is a need to develop better utilization of the existing coils provided in a device.

### Summary

In view of the hardware resource utilization issue in a wireless power transfer system, embodiments described herein provide a method for operating a wireless power transfer device as a metal detector. The method includes driving a transmitter coil with an input voltage from a power supply, and monitoring a current that passes through or a voltage across the transmitter coil. The method further includes detecting a change in the current or the voltage, and determining whether the change in the current or the voltage satisfies a threshold condition. The method further includes generating, via a user interface, an indication of a presence of a metal object in vicinity of the wireless power transfer device when the change in the current or the voltage satisfies the threshold condition.

Embodiments described herein further provide a wireless power transfer device for metal detection. The wireless power transfer device includes a transmitter coil, a controller, and a user interface. The controller is configured to drive the transmitter coil with an input voltage from a power supply, monitor a current that passes through or a voltage across the transmitter coil, detect a change in the current or the voltage, and determine whether the change in the current or the voltage satisfies a threshold condition. The user interface is configured to generate for display an indication of a presence of a metal object in vicinity of the wireless power transfer device when the change in the current or the voltage satisfies the threshold condition.

These and other embodiments are discussed below with respect to the following figures.

### BRIEF DESCRIPTION OF THE FIGURES

FIG. 1 illustrates an example wireless power transmission system that transfers wireless power via electromagnetic induction through an inductive coil, according to some embodiments.

FIG. 2 illustrates a device that includes an inductive coil to generate an electromagnetic field as discussed in relation to FIG. 1, according to some embodiments described herein.

FIG. 3 illustrates the device shown in FIG. 2 detecting a foreign object by measuring the change in the electromagnetic field, according to some embodiments described herein.

FIG. 4 provides example user interface (UI) diagrams showing the UI of a device for a metal detection mode, according to embodiments described herein.

FIG. 5 shows an example logic flow diagram illustrating a process of operating a

These and other aspects of embodiments of the present invention are further discussed below.

### DETAILED DESCRIPTION

In the following description, specific details are set forth describing some embodiments of the present invention. It will be apparent, however, to one skilled in the art that some embodiments may be practiced without some or all of these specific details. The specific embodiments disclosed herein are meant to be illustrative but not limiting. One skilled in the art may realize other elements that, although not specifically described here, are within the scope and the spirit of this disclosure.

This description illustrates inventive aspects and embodiments should not be taken as limiting—the claims define the protected invention. Various changes may be made without departing from the spirit and scope of this description and the claims. In some instances, well-known structures and techniques have not been shown or described in detail in order not to obscure the invention.

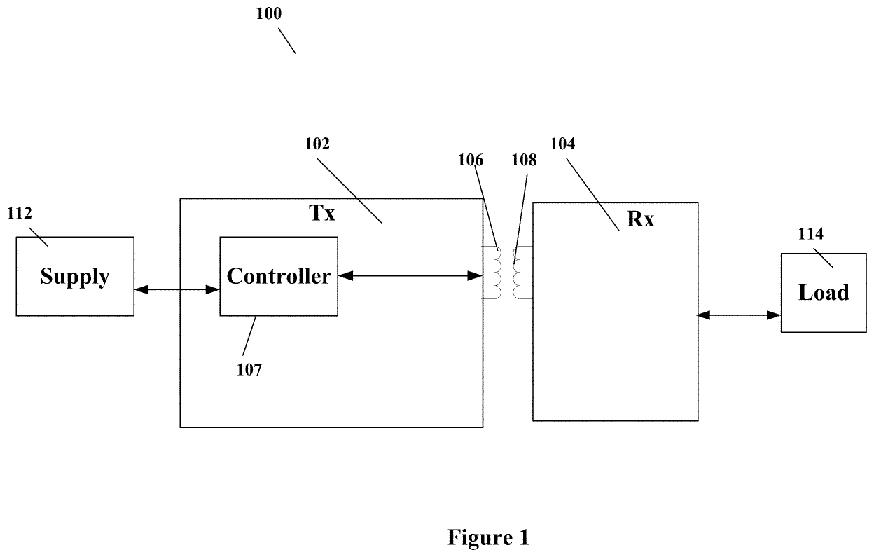

FIG. 1 illustrates an example wireless power transmission system 100 that transfers wireless power via electromagnetic induction through an inductive coil, according to some embodiments. As illustrated in FIG. 1, a power transmitter TX 102 is coupled to receive an input voltage from a power supply 112 and drive a transmitter coil 106 to produce a time varying magnetic field. The time varying magnetic field induces a current in the receiver coil 108, when the receiver coil 108 is placed within a physical range of the magnetic field. Receiver coil 108 is coupled to power receiver RX 104, which receives the transmitted wireless power. RX 104 is coupled to a load 114, for example, a battery charger, which is configured to charge a battery with the received power.

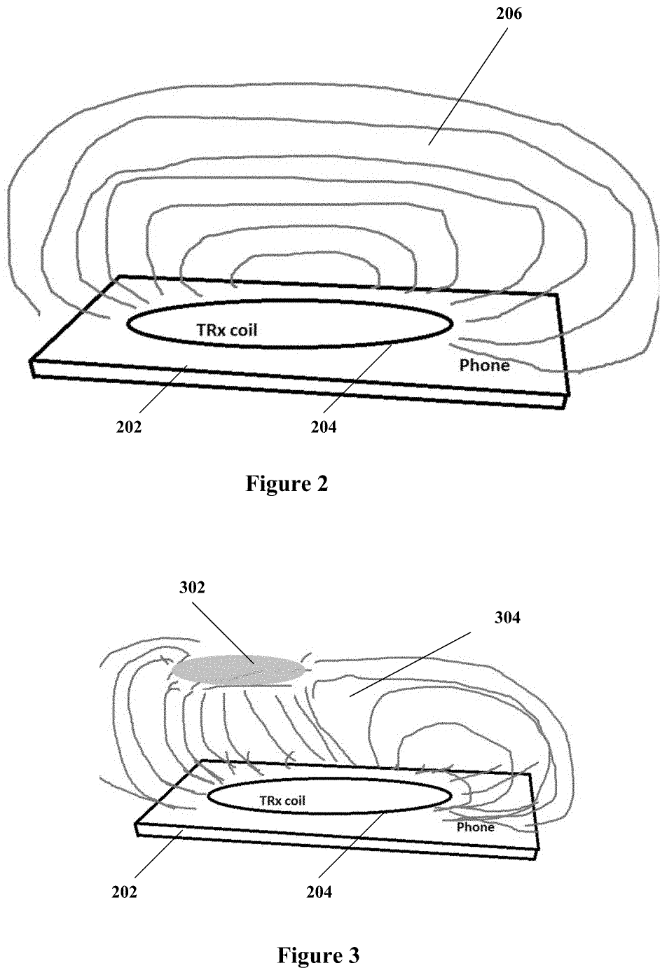

For example, FIG. 2 illustrates a device 202 that includes an inductive coil 204 to generate an electromagnetic field as discussed in relation to FIG. 1, according to some embodiments described herein. The device 202 may be any of a Smartphone, a cell phone, a wireless charger, a tablet computer, a wearable device, a personal digital assistant (PDA), or any other devices that include an inductive coil 106. The inductive coil 204 can be configured as a transmitter coil (similar to 106) or a receiver coil (similar to 108) coil, or a separate transmitter coil. The device 202 includes the TX component 102 that provides an AC current to the coil 204 to generate an electromagnetic field 206 as illustrates.

Back to FIG. 1, the TX 102 includes a controller 107 that is configured to execute processor-readable instructions to control the operation of TX 102. For example, the controller 107 is configured to control a switching circuit (not shown) within TX 102 to provide an alternate current (AC) to the transmitter coil 106 to create the electromagnetic field 206, monitor the voltage across and/or the current through the transmitter coil 106, determine whether or not a ferrous object is proximate to the transmitter coil 106, and provide an indication to a user of the presence of the ferrous object.

The TX 102 and the transmitter coil 106 have conventionally been used for wireless power transfer. To improve hardware resource efficiency of a device having been equipped with TX 102 and the coil 106, embodiments described herein provide a method of operating TX 102 and the coil 106 for foreign object detection or intentional metal detection. For example, as an embodiment of wireless power transfer, TX 102 is configured to detect metal objects in the vicinity of the transmitter coil 106 (e.g., when an object is placed on the surface of device 202), using Q measurements or, usually during wireless transfer, using power loss to detect the objects presence. Thus, the device 202 can be used to create a metal detector, e.g., for identifying a location of lost metal objects in hard-to-reach places, such as in the sand, mud, etc.

The device 202, as shown in FIG. 2, when configured in a TX mode, can be used to scan an area for the presence of a metal object by providing Q measurement or a digital PING and taking some measurements. For example, Smartphones now usually include a strong electromagnetic field generator and thus can provide a way to monitor for impedance facing the generator or current into the generator.

When the coil 204 is energized with an AC voltage upon a user command to device 202, the electromagnetic field 206 is created. Measurable attributes, such as the voltage across the coil 204, or the current through the coil 204, and/or any changes in the voltage or the current, can indicate whether a ferrous object is located in the vicinity of the electromagnetic field 206. Such measurable attributes can also be used to estimate the size and/or proximity of the foreign object.

For example, FIG. 3 illustrates the device 202 shown in FIG. 2 detecting a foreign object 302 by measuring the change in the electromagnetic field 304, according to some embodiments described herein. When a metal object 302 is placed in vicinity to the coil 204, the electromagnetic field is altered by the presence of the metal object 302, as illustrated at field 304. Specifically, as the metal object 302 may be inductive, electromagnetic fields may be generated between the metal object 302 and the coil 204, thus changing the original electromagnetic field 206 in the absence of any metal object. This alteration can be reflected by measurable feedback at the electromagnetic field generator (coil 204 and device 202 in this case). The shape of the altered electromagnetic field 304 is changed in relation to the shape and size of the metal object 302. A detector can be built to capture this change and provide an indication to a user that the metal object 302 has been located.

The voltage across the coil 204 is reduced proportionally to the size, density and proximity of the object 302. For example, the closer the metal object 302 is to the coil 204, or the larger the metal object 302 is in size, or the higher the density of the metal object 302 is, the more the voltage across the coil 204 may be reduced. In addition, the current in coil 104 will increase proportionally to the size, density and proximity of object 202. For example, the closer the metal object 302 is to the coil 204, or the larger the metal object 302 is in size, or the higher the density of the metal object 302 is, the more the current across the coil 204 may be increased. Device 202 can then use the measured changes in the voltage or current at the coil 204 to detect the presence of the metal object 302, creating a metal detector function for device 202.

Some objects may not as readily respond to electromagnetic fields, such as gold, silver, and/or other metals that do not respond to electromagnetic fields. Objects made of such materials can be detected by using the transmitter coil 106 as part of a capacitor, which is configured to generate an electric field when a direct current passes through the transmitter coil 106. The controller 107 is configured to monitor and sense any change in the electrostatic charge stored across a resonance capacitor that is coupled in series with the Tx coil 106. The electric field is created by: first charging the entire Tx coil 106 to be at a fixed voltage, and then monitoring the discharge of the fixed voltage. The controller 107 is then configured to obtain a discharge rate. When a conductive object is placed in vicinity to the Tx coil 106, the discharge rate is faster through capacitive coupling between the Tx coil 106 and the object than that without an object nearby. For example, when the voltage decay rate (e.g., the discharge rate) at the Tx coil 106 is greater than a threshold rate, the control 107 determines that a conductive object is nearby.

Consequently, device 202 can execute an algorithm that drives coil 204 to create the electromagnetic field 206 or an electric field (when the object may not respond to the magnetic field). In the presence of an object 302, field 206 is distorted to a distorted field 304. These fields are fed back in the form of reduced voltage across coil 104 and increased current through coil 204, which can be detected by device 202. Device 202 can then indicate the presence of object 302.

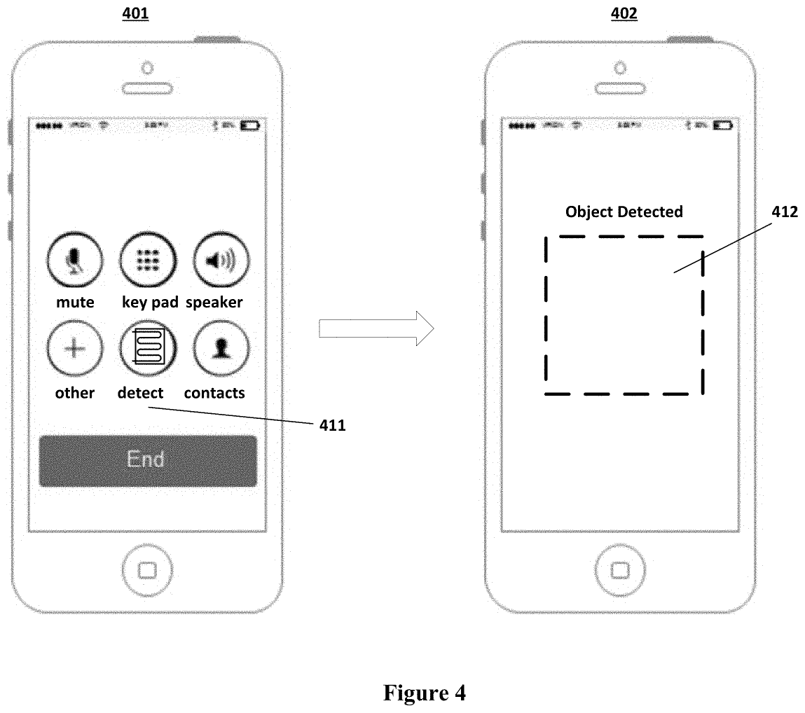

FIG. 4 provides example user interface (UI) diagrams showing the UI of device 202 for a metal detection mode, according to embodiments described herein. For example, UI screen 401 of device 202 shows a swipe-up menu including a metal detection mode 411. A user may launch the metal detection mode 411 to operate device 202 as a metal detector. In response to an input command at the user interface of device 202, the device 202 may in turn drive the transmitter coil 204 with an input voltage or current. UI screen 402 shows that when a metal object is detected in vicinity of the device 202, the UI of device 202 displays an indication of the presence of the metal object. For example, UI screen 402 may display a live image of the environment where the device 202 is disposed, captured by a camera of the device 202, and a visual element 412 overlaying the live image, showing a location range in the environment for the metal object. In this way, even if the metal object may not be visible in the environment, e.g., covered by leaves, sand, etc., device 202 provides an indication of the approximate location of the object.

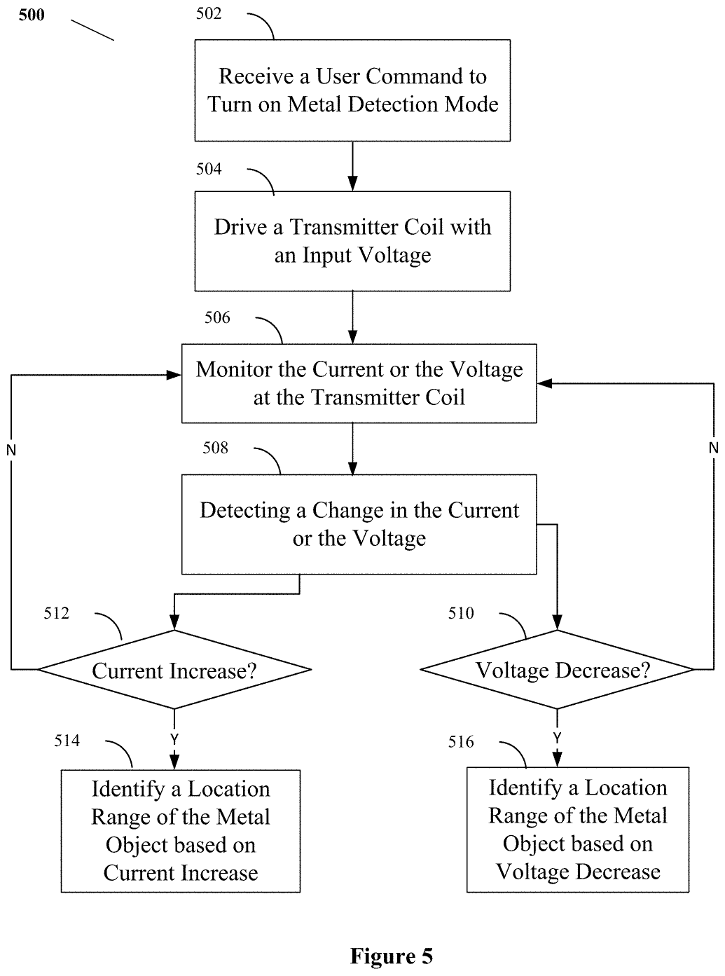

FIG. 5 shows an example logic flow diagram illustrating a process 500 of operating a wireless power transfer device 202 as a metal detector, according to embodiments described herein. At step 502, a user command is received to turn on the metal detection mode for device 202, e.g., via user interface 401. At step 504, a transmitter coil (e.g., 204) is driven with an input voltage, in response to the user command. At step 506, the current or the voltage at the transmitter coil 204 is monitored. At step 508, a change in the current or the voltage at the transmitter coil is detected.

Steps 512 and 510 may be implemented concurrently, consecutively in any order, or individually. At step 512, the device 202 determines whether the change in the current includes a current increase. Process 500 goes back to step 506 to continue monitoring, if no current increase is detected. If the current increase is detected and the current increase is greater than a threshold amount, at step 514, the device 202 identifies a location range of a metal object, e.g., in vicinity to the device 202 based on an amount of the current increase.

At step 510, the device 202 determines whether the change in the voltage includes a voltage decrease. Process 500 goes back to step 506 to continue monitoring, if no voltage decrease is detected. If the voltage decrease is detected and the voltage decrease is greater than a threshold amount, at step 516, the device 202 identifies a location range of a metal object, e.g., in vicinity to the device 202 based on an amount of the voltage decrease.

The above detailed description is provided to illustrate specific embodiments of the present invention and is not intended to be limiting. Numerous variations and modifications within the scope of the present invention are possible. The present invention is set forth in the following claims.

What is claimed is:

1. A method for operating a wireless power transfer device as a metal detector, comprising:
driving a transmitter coil with an input voltage from a power supply;
monitoring a current that passes through or a voltage across the transmitter coil;
detecting a change in the current or the voltage;
determining whether the change in the current or the voltage satisfies a threshold condition; and
generating, via a user interface, an indication of a presence of a metal object in vicinity of the wireless power transfer device when the change in the current or the voltage satisfies the threshold condition.

2. The method of claim 1, further comprising:
receiving, via a user interface, a command to turn on a metal detection mode; and
in response to the received command, driving the transmitter coil with the input voltage.

3. The method of claim 1, wherein the current that passes through the transmitter coil is an alternate current, and the method further comprises:
generating, at the transmitter coil, an electromagnetic field in accordance with the alternate current that passes through the transmitter coil.

4. The method of claim 1, wherein the determining whether the change in the current or the voltage satisfies the threshold condition comprises:
determining whether the change in the current indicates an increase; and
determining whether an increased amount in the current exceeds a threshold value when the change in the current indicates an increase.

5. The method of claim 1, wherein the determining whether the change in the current or the voltage satisfies the threshold condition comprises:
determining whether the change in the voltage indicates a decrease; and
determining whether a decreased amount in the voltage exceeds a threshold value when the change in the voltage indicates a decrease.

6. The method of claim 1, further comprising:
measuring a quantity of the change in the current or the voltage; and
determining a range of location for the metal object when the change in the current or the voltage satisfies the threshold condition.

7. The method of claim 6, wherein the generating, via the user interface, the indication of a presence of a metal object in vicinity of the wireless power transfer device when the change in the current or the voltage satisfies the threshold condition comprises:
generating, on the user interface, a visual element overlaying a live image of an environment in which the wireless power transfer device is disposed, wherein the visual element indicates a location of the metal object in the environment.

8. A wireless power transfer device for metal detection, comprising:
a transmitter coil;
a controller configured to:
drive the transmitter coil with an input voltage from a power supply;
monitor a current that passes through or a voltage across the transmitter coil;
detect a change in the current or the voltage;
determine whether the change in the current or the voltage satisfies a threshold condition;
a user interface configured to generate for display an indication of a presence of a metal object in vicinity of the wireless power transfer device when the change in the current or the voltage satisfies the threshold condition.

9. The device of claim 8, wherein the user interface is further configured to receive a command to turn on a metal detection mode, and the controller is further configured to:
in response to the received command, drive the transmitter coil with the input voltage.

10. The device of claim 8, wherein the input voltage is an alternate voltage, and the current that passes through the transmitter coil is an alternate current, and the transmitter coil is configured to:
generate a magnetic field in accordance with the alternate current that passes through the transmitter coil.

11. The device of claim 8, wherein the input voltage is a stable direct current input voltage, and the current that passes through the transmitter coil is a direct current, and the transmitter coil is configured to:
generate an electric field in accordance with the direct current while the direct current charges a resonance capacitor that is series coupled to the transmitter coil.

12. The device of claim 8, wherein the controller is further configured to determine whether the change in the current or the voltage satisfies the threshold condition by:
determining whether the change in the current indicates an increase; and
determining whether an increased amount in the current exceeds a threshold value when the change in the current indicates an increase.

13. The device of claim 8, wherein the controller is further configured to determine whether the change in the current or the voltage satisfies the threshold condition by:
determining whether the change in the voltage indicates a decrease; and
determining whether a decreased amount in the voltage exceeds a threshold value when the change in the voltage indicates a decrease.

14. The device of claim 8, wherein the controller is further configured to determine whether the change in the current or the voltage satisfies the threshold condition by:
determining a voltage decay rate across the transmitter coil based on the change in the voltage; and
determining whether the voltage decay rate is higher than a threshold rate indicative of influence of an object nearby.

15. The device of claim 8, wherein the controller is further configured to:
measure a quantity of the change in the current or the voltage; and
determine a range of location for the metal object when the change in the current or the voltage satisfies the threshold condition.

16. The device of claim 15, wherein the user interface is further configured to generate for display a visual element overlaying a live image of an environment in which the wireless power transfer device is disposed, wherein the visual element indicates a location of the metal object in the environment.

17. A system for operating a wireless power transfer device as a metal detector, comprising:
means for driving a transmitter coil with an input voltage from a power supply;
means for monitoring a current that passes through or a voltage across the transmitter coil;
means for detecting a change in the current or the voltage;
means for determining whether the change in the current or the voltage satisfies a threshold condition; and
means for generating, via a user interface, an indication of a presence of a metal object in vicinity of the wireless power transfer device when the change in the current or the voltage satisfies the threshold condition.

18. The system of claim 17, wherein the input voltage is an alternate voltage, and the current that passes through the transmitter coil is an alternate current, and the system further comprises:
means for generating, at the transmitter coil, an electromagnetic field in accordance with the alternate current that passes through the transmitter coil.

19. The system of claim 17, wherein the input voltage is a stable direct current input voltage, and the current that passes through the transmitter coil is a direct current, and the system further comprises:
means for generating an electric field in accordance with the direct current while the direct current charges a resonance capacitor that is series coupled to the transmitter coil

20. The system of claim 17, wherein the means for determining whether the change in the current or the voltage satisfies the threshold condition comprises:
means for determining whether the change in the current indicates an increase; and
means for determining whether an increased amount in the current exceeds a threshold value when the change in the current indicates an increase.

21. The system of claim 17, wherein the means for determining whether the change in the current or the voltage satisfies the threshold condition comprises:
means for determining whether the change in the voltage indicates a decrease; and
means for determining whether a decreased amount in the voltage exceeds a threshold value when the change in the voltage indicates a decrease.

22. The system of claim 17, wherein the means for determining whether the change in the current or the voltage satisfies the threshold condition comprises:
means for determining a voltage decay rate across the transmitter coil based on the change in the voltage; and
means for determining whether the voltage decay rate is higher than a threshold rate indicative of influence of an object nearby.
